(19) United States
(12) Patent Application Publication
(10) Pub. No.: US 2026/0170512 A1
(43) Pub. Date: Jun. 18, 2026

(54) METHODS, SYSTEMS, ARTICLES OF MANUFACTURE AND APPARATUS TO DECOMPOSE BIAS

(71) Applicant: Nielsen Consumer LLC, Chicago, IL (US)

(72) Inventors: Gabor Szep, Budapest (HU); Valentin Tachev, Oxford (GB); Salvador Ulloa Solis, Mexico City (MX); Rafael Pablo Torres Bravo, Santiago de Chile (CL); Vadym Safronov, Lisbon (PT)

(21) Appl. No.: 18/850,976

(22) PCT Filed: Aug. 22, 2024
(86) PCT No.: PCT/US2024/043427

§ 371 Date: Sep. 25, 2024

Related U.S. Application Data
(60) Provisional application No. 63/578,143, filed on Aug. 22, 2023.

(51) Int. Cl. G06Q 30/0201

(52) U.S. Cl. CPC G06Q 30/0201

(57) ABSTRACT

Methods, systems, articles of manufacture and apparatus to decompose bias are disclosed. A disclosed example non-transitory machine-readable medium includes machine-readable instructions to cause at least one processor circuit to at least decompose at least one bias of first consumer panel services (CPS) data, and adjust a de-noising model based on the at least one bias, the de-noising model to generate retail measurement services (RMS) data based on second CPS data corresponding to a non-cooperating retailer.

### RELATED APPLICATION

This patent arises as a national phase of International Application No. PCT/PCT/US2024/043427, which was filed on Aug. 22, 2024, and claims the benefit of U.S.

Provisional Patent Application No. 63/578,143, which was filed on Aug. 22, 2023. International Application No. PCT/PCT/US2024/043427 and U.S. Provisional Patent Application No. 63/578,143 are hereby incorporated herein by reference in their entireties. Priority to International Application No. PCT/PCT/US2024/043427 and U.S. Provisional Patent Application No. 63/578,143 is hereby claimed.

### FIELD OF THE DISCLOSURE

This disclosure relates generally to data science modeling and, more particularly, to methods, systems, articles of manufacture and apparatus to decompose bias.

### BACKGROUND

In recent years, data science has sought new insight from data analysis to improve computational technologies.

### BRIEF DESCRIPTION OF THE DRAWINGS

FIG. 1 is a block diagram of an example framework in accordance with teachings of this disclosure.

FIG. 2 is a block diagram of example bias circuitry to decompose bias.

FIGS. 3 and 4 are flowcharts representative of example machine readable instructions and/or example operations that may be executed, instantiated, and/or performed by example programmable circuitry to implement the bias circuitry of FIG. 2.

FIG. 5 is a block diagram of an example processing platform including programmable circuitry structured to execute, instantiate, and/or perform the example machine readable instructions and/or perform the example operations of FIGS. 3 and 4 to implement the bias circuitry of FIG. 2.

FIG. 6 is a block diagram of an example implementation of the programmable circuitry of FIG. 5.

FIG. 7 is a block diagram of another example implementation of the programmable circuitry of FIG. 5.

FIG. 8 is a block diagram of an example software/firmware/instructions distribution platform (e.g., one or more servers) to distribute software, instructions, and/or firmware (e.g., corresponding to the example machine readable instructions of FIGS. 3 and 4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Methods, systems, articles of manufacture and apparatus to decompose (e.g., identify, label and/or otherwise categorize) bias are disclosed. For data science modeling, in particular consumer data science modeling, estimation of data for a non-cooperating entity (e.g., an entity such as a retailer that does not participate in providing and/or otherwise sharing data with market researchers corresponding to sales activity, shipment activity, etc.) can be challenging. There are numerous known solutions to estimate data that can be implemented depending on available resources. However, current known industry methodologies to estimate the data can require much more extensive data collection and computational requirements. In particular, known methodologies to decompose bias include crowd sourcing, cash slip store intercept, etc. However, such known methodologies can necessitate extensive data collection, which can, in turn, require extensive computational backhaul to incorporate resulting output(s) into a form that is useful for analysis.

Measurement quality may be determined based on sales data, in which shipment data is compared to sales data to provide an indication of coverage. As used herein, “coverage” refers to a quantity of product sold in a market (or other geographic area) of interest. However, obtaining accurate shipment data is not always available. When shipment data is available from, for example, manufacturers, it can fail to provide information regarding sales activity, etc. Additionally, in the event only a single manufacturer shares its shipment data, data associated with brand share may be inconsistent when such data comes from different sources (e.g., different sources from the same manufacturer).

Examples disclosed herein enable extraction of retail data corresponding to a non-cooperating retailer based on consumer panel data. Examples disclosed herein can determine and/or generate retail measurement services (RMS) data of a non-cooperating retailer from consumer panel services (CPS) (sometimes referred to as panelist data) data. The RMS data corresponds to a measurement of sales corresponding to a retailer (e.g., in a continuous and/or a periodic basis). The CPS data corresponds to a panel based service where consumer sales information is collected (e.g., on a regular basis). As used herein, the term “cooperating retailer” refers to a retailer that provides RMS sales data (e.g., on a continuous basis) while the term “non-cooperating retailer” refers to a retailer that does not provide RMS data (or related data). As used herein, the term “participating manufacturer” refers to a manufacturer that supports sharing information associated with an estimation process (e.g., by sharing shipment data corresponding to cooperating and non-cooperating retailers). Conversely, the term “non-participating manufacturer” corresponds to a manufacturer that is not sharing information associated with the estimation process (e.g., other manufacturers who produce in same/similar categories but do not share such information).

To extract valuable RMS data with respect to a non-cooperating retailer, examples disclosed herein determine bias related to CPS data. Generally speaking, CPS data is based on demographically selected participants that voluntarily disclose their behaviors throughout a period of time (e.g., in a survey). Maintaining a degree of integrity for CPS participants can be expensive and time-consuming because, in part, the participants are required to satisfy reporting tasks in exchange for compensation. The data obtained from CPS techniques is considered a “gold standard” for its own purposes: for finding answers for the question of why a market changes, but it does not satisfy the standards of RMS service requirements, which is not applicable to measure the market size and brand shares. In some examples, RMS data is obtained from retail scanning devices in which each UPC results in a data point. While every UPC in RMS data can be associated with an accurate time of purchase, date of purchase, price and/or promotional discount information associated with the purchase, the RMS data is devoid of demographic characteristics. Examples disclosed herein can provide an insight into relationships between CPS data and RMS data, which can be particularly advantageous for retail businesses, for example. Examples disclosed herein can be particularly advantageous in extracting RMS data with respect to retailers that are non-cooperating.

CPS data can be particularly affected by bias, thereby rendering such RMS data to be inaccurate. While CPS data provides insight into specific demographic panelists and their purchasing behaviors that can be extrapolated, CPS data is volume-limited and can be limited with respect to quantities of such purchasing behaviors over larger sample sizes. RMS data, on the other hand, can be relatively more voluminous than CPS data. As mentioned above, bias can be a key issue in efforts to utilize CPS data to create RMS-like data. Examples disclosed herein can effectively reduce and/or eliminate the effects of such bias, thereby enabling significantly accurate modelling and/or prediction of sales, inventory, stock depletion, etc. based on CPS data. As a result, examples disclosed herein can accurately determine RMS estimates with a reduced amount of data in comparison to known RMS estimation techniques, thereby reducing computational burdens and/or data information transfer burdens associated with crowd sourcing, cash slip store intercept, etc.

CPS data may not represent purchasing behaviors corresponding to retailers of interest, but may represent a more generalized population, which may inherently have a degree of bias. CPS data includes information that panelists report about their own behaviors, but such reporting may be delayed with respect to an occurrence of actual behavior. Additionally, the panelists may self-reflect on and/or cause distortion of their purchasing behaviors in view of how such information is collected, summarized and/or otherwise presented, which also introduces a bias element. Some panelists do not like to share particular purchasing behaviors, such as alcohol purchases, which can also introduce bias.

Data scientists that attempt to use available data may observe that coverage is over-represented or under-represented, such as when a manufacturer is aware of 100 shipped units of product, but only 50 units of product are reported after a data analysis. Examples disclosed herein decompose bias effects or, stated differently, parse and/or subdivide reasons why bias may appear. In some examples, bias drivers (e.g., bias factors, bias values, etc.) are determined and/or otherwise quantified to enable later adjustment thereof via a model (e.g., a de-noising model). In contrast to known implementations that utilize time-consuming and extensive data collection that inherently necessitates excess computational resources, examples disclosed herein determine and utilize bias drivers to avoid a significant degree of complexity of known implementations, thereby effectively reducing computational resources typically needed to calculate relatively complex models and/or simulations.

To mitigate the effects of bias, examples disclosed herein utilize a pipeline model in conjunction with a de-noising model such that at least one bias is decomposed (e.g., at least one bias is extracted and separated into a relevant category) by the de-noising model for determination of non-cooperating retailer data (e.g., RMS data corresponding to a non-cooperating retailer). For example, multiple biases of different categories (e.g., retailer biases, category biases, brand biases, promotional biases, etc.) can be extracted from the CPS data by the de-noising model for determination of RMS data. According to examples disclosed herein, the de-noising model can be trained with output from the pipeline model in conjunction with other data, such as cooperating retailer RMS data, cooperating retailer CPS data, non-cooperating retailer RMS data (e.g., estimated non-cooperating retailer RMS data), non-cooperating retailer CPS data, shipment data, etc. In an implementation phase, the de-noising model is utilized to determine and/or extract data (e.g., RMS data) associated with a non-cooperating retailer, for example.

In some examples disclosed herein, the de-noising model is operated in tandem with the pipeline model. In some such examples, the aforementioned output of the de-noising model includes non-cooperating retailer RMS data. In some examples, the at least one bias is decomposed by reducing (e.g., minimizing) a difference between a known RMS value and an RMS estimate (e.g., an RMS estimate provided by the pipeline model). In some examples, the pipeline model is provided with and/or trained with cooperating retailer shipment data and cooperating retailer RMS data. According to some examples disclosed herein, the pipeline model is provided with shipment data corresponding to a non-cooperating retailer as an input provided thereto. In some examples, the de-noising model adjusts weighting of different bias values/factors/categories. Additionally or alternatively, the pipeline model and the de-noising model are both provided with RMS data that is associated with a cooperating retailer as input for training thereof. In some examples, the de-noising model is provided with data (e.g., CPS data, RMS data, etc.) corresponding to a cooperating retailer and a non-cooperating retailer for training thereof.

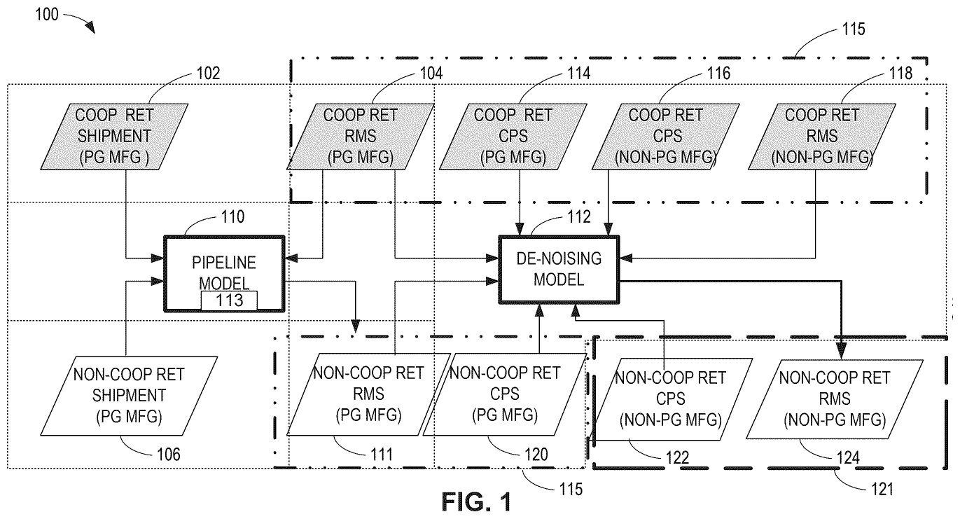

FIG. 1 is a block diagram of an example framework 100 in accordance with teachings of this disclosure. In the illustrated example of FIG. 1, participating manufacturer (PG MFG) shipment data 102 corresponding to shipments to a cooperating retailer (COOP RET) is shown. The example shipment data 102 can include volume information (e.g., shipment volume, shipment history, etc.) corresponding to the cooperating retailer. Further, in this example, RMS data 104, which corresponds to the same cooperating retailer and a participating manufacturer, is obtained. In the example framework 100 of FIG. 1, the participating manufacturer's (PG MFG) shipment data 106 corresponds to a non-cooperating retailer (NON-COOP RET). For example, the shipment data 106 can correspond to derived information of the non-cooperating retailer. Accordingly, this dichotomy between a participating manufacturer and a non-cooperating retailer is important to note in the context of examples disclosed herein.

In this example, the shipment data 102 and the RMS data 104 are utilized to train a pipeline model 110. Further, the shipment data 106 is provided as an input to a pipeline model 110. In turn, the pipeline model 110 provides non-cooperating retailer RMS data (e.g., an RMS data estimate for the non-cooperating retailer) 111 as output to an example de-noising model 112.

The example pipeline model 110 implements and/or defines a remaining stock model 113. For example, weekly sales are allocated to product retail sales and, at the beginning of a week, there is a certain amount of the product that is available in a store. Shipment days may occur during any day of the week, and, thus, in some examples, more product may be available at the store during different days/time periods of a week. During the week, a certain amount of product is sold, but some remains in stock. The amount of product that is sold depends on, in part, whether the product is promoted or not. If the product is promoted (e.g., leaflets, temporary price reductions (TPRs), sales advertisement, store display, etc.), then more sales can result. Example Equation 1 below illustrates an example expression utilized by the example pipeline model 110, which can be based on a remaining stock model:

$${Sa}_{t} = ( 1 - {P}_{t} ) α \hat{S} {t}_{t} + {P}_{t} β \hat{S} {t}_{t} , \qquad ( 1 )$$

where αŜtₜ=non-promotional sales, where:
PₜβŜtₜ=sales under promotion, where Pₜ=promotional flag, 0 or 1 (or can be a probability), and where Ŝtₜ=available stock in the beginning of the period. The available stock and/or remaining stock scan also be expressed as example Equation 2 below:

$$\hat{S} {t}_{t} = \hat{S} {t}_{t - 1} - {Sa}_{t - 1} + {Sh}_{t} ( apply delay ) \qquad ( 2 )$$

According to examples disclosed herein, an Alpha (α) coefficient/percentage (e.g., an alpha percentage scaler, a ratio, a parameter, etc.) corresponds to non-promoted circumstances, and a Beta (β) coefficient/percentage (e.g., a beta percentage scaler, a ratio, a parameter, etc.) corresponds to promoted circumstances. In this example, shipment data is received/accessed from a client (e.g., a manufacturer) on a weekly basis (e.g., as item data). Further, Alpha and Beta coefficient/parameters of example Equation 1 can be derived from training iterations. In particular, the example pipeline model 110 can be trained and/or adjusted based on known real sales and/or shipment data. The Alpha and Beta coefficient/parameters of example Equations 1 and 2 are, after training, applied to the shipment data 106 to calculate and/or determine sales (e.g., retail sales) at an item level (see the non-cooperating retailer RMS data 111).

The example framework 100 also includes the aforementioned example de-noising model 112, which takes into account biases for estimation of non-cooperating retailer RMS data. In the example of FIG. 1, the de-noising model 112 is operated to utilize CPS data to accurately determine RMS data corresponding to the non-cooperating retailer and a non-participating manufacturer, which would otherwise be inaccessible or difficult to obtain. In the illustrated example of FIG. 1, the de-noising model 112 is trained with data corresponding to groups of data 115. In this particular example, the de-noising model is trained with the aforementioned example cooperating retailer RMS data 104, example cooperating retailer CPS data 114 corresponding to the participating manufacturer, example cooperating retailer CPS data 116 corresponding to a non-participating manufacturer (non-PG MFG), and example cooperating retailer RMS data 118 corresponding to the non-participating manufacturer. Additionally, the example de-noising model 112 is trained and/or provided with the example non-cooperating retailer RMS data 111, and example non-cooperating retailer CPS data 120 corresponding to the participating manufacturer. However, any other appropriate combination of training data can be implemented instead. For example, the non-cooperating retailer CPS data 120 can be utilized as input to the de-noising model 112 instead of acting as training data.

In an implementation phase, as shown by groups of data 121, the de-noising model 112 is provided with example non-cooperating retailer CPS data 122 corresponding to any non-participating manufacturer as input thereto. In turn, the example de-noising model 112 outputs-non-cooperating retailer RMS data 124 corresponding to any non-participating manufacturer. Accordingly, the de-noising model 112 may advantageously utilize survey data corresponding to a non-cooperating retailer and a non-participating manufacturer and is advantageously able to extract corresponding RMS data, which can ordinarily difficult and time-consuming to estimate without cooperation of retail and manufacturing entities.

With respect to biases (e.g., retailer biases, brand biases, promotional biases, etc.) in view of an example product and an example retailer, the product may be a particular brand label, it may be promoted or non-promoted and/or otherwise promoted in different ways, different size products, different product packaging. Sales of the product may be affected by any number of parameters like this, and bias may be affected by such parameters, as well. Examples disclosed herein attempt to quantify these biases to accurately adjust RMS data that may not be readily available or accessible. A cooperating retailer can share their RMS data, and, in contrast, CPS data can provide household specific detail (e.g., demographic information). Decomposition efforts can enable effective understanding of the relationship between both of these types of data. At least one objective is to estimate RMS sales in a manner consistent with example Equation 3.

$${RMS}_{{Sales}_{i , j , k , l}} = {CPS}_{{Sales}_{i , j , k , l}} * {Retailer}_{{bias}_{i}} * {Brand}_{{bias}_{k}} * {Promo}_{{bias}_{l}} \qquad ( 3 )$$

In the example of Equation 3, CPS_sales represents consumer sales for the same product brand, expanded to the population of households, Retailer_bias represents a specific bias corresponding to retailer i, Category_bias represents a specific bias for category j, Brand_bias represents a specific bias for brand group k, and Promo_bias represents a specific bias for promotional group l. In some examples, CPS_sales, Retailer_bias, Brand_bias and Promo bias are referred to as features, all having corresponding values or magnitudes of influence.

In the example of Equation 3, the RMS sales are known and the CPS sales are known, but the feature values (e.g., bias) may not all be known. While the illustrated example of Equation 3 includes four (4) features, examples disclosed herein are not limited thereto. Further examples disclosed herein, can be related to any other appropriate type of bias category. Some examples disclosed herein solve an optimization problem in a manner consistent with example Equation 4:

$$( 4 )$$

$${\sum }_{i , j , k , l} [ {weight}_{i , j , k , l} * abs ( {knownRMSsales}_{i , j , k , l} - {estimatedRMSsales}_{i , j , k , l} ) ]$$

In some examples, Equation 4 can be solved to be optimized by solving for an overall sum of zero (e.g., the net value is zero) or as close to zero as possible for determining bias factors.

Cross combinations of different biases/bias categories/features may be included resulting in additional equations to be solved simultaneously (e.g., via a system of equations). For example, some bias can be introduced based on quantities of sales. In a particular example, soda sales may be voluminous enough to be statistically significant, while baby food sales may have substantially fewer representative samples. As such, the possibility remains that both soda sales and baby food sales actually have relatively similar sales volumes, but the disproportionate sample sizes can cause erroneous conclusions (bias). To mitigate this bias, weights are applied to address this disproportionate representation. In some examples, a sum of Equation 4 may be minimized. To that end, by solving the system of equations in a relatively simple and simultaneous manner, examples disclosed herein can solve the equations in a highly computationally efficient manner, thereby saving time, power, computing resources, etc. Further, examples disclosed herein save computing resources by reducing and/or eliminating a necessity for a wide array of data sources that can involve a need for complex simulations and/or data analysis techniques. In particular, known techniques include crowd sourcing, cash slip store intercept, etc. that can involve a relatively large amount of data that has to be processed, thereby requiring extensive time, computational resource usage. Accordingly, examples disclosed herein can forego the need for extensive data collection that is difficult to find and obtain, and reduce computational requirements associated with the extensive data collection. In some examples, known techniques may identify suspected bias in output values and automatically invoke one or more re-computation efforts to mitigate the suspected bias. For instance, some known techniques invoke remediation procedures such as additional crowd sourcing data requests under the suspicion that additional RMS and/or CPS data may still be available for further analysis. However, examples disclosed herein may operate in conjunction with some known techniques to block and/or otherwise interrupt computationally wasteful mitigation efforts that may not necessarily improve the accuracy of the analysis effort. Such blocking/interruption of known mitigation tasks are automatically invoked, thereby conserving valuable computation resources and/or bandwidth while examples disclosed herein are applied.

In example operation (e.g., during an execution phase as opposed to a training phase), the pipeline model 110 and the de-noising model 112 can be operated in tandem such that the pipeline model 110 is utilized for estimating RMS sales data of a non-cooperating retailer with respect to a participating manufacturer while the de-noising model 112 is implemented to generate estimates of non-cooperating retailer RMS sales data with respect to a non-participating manufacturer. In other words, examples disclosed herein can extract, estimate and/or extrapolate RMS data from non-cooperating retailers in conjunction with non-participating manufacturers (or shippers/distributors, etc.). Additionally or alternatively, the pipeline model 110 and the de-noising model 112 are re-trained and/or adjusted periodically. In some examples, the pipeline model 110 and the de-noising model 112 are re-trained and/or adjusted based on an age of the data, staleness of the data, changes in data and/or a period of time elapsing since the prior training/adjustment. This re-training and/or adjusting can advantageously ensure that bias factors are accurately accounted for in view of dynamic market conditions.

As mentioned above, the shipment data 102, and the cooperating retailer RMS data 104 are utilized to train the pipeline model 110 such that parameters and/or coefficients are adjusted, for example. Further, the cooperating retailer RMS data 104, the cooperating retailer CPS data 114, the example cooperating retailer CPS data 116, the cooperating retailer RMS data 118, the non-cooperating retailer RMS data 111 and the non-cooperating retailer CPS data 120 are utilized to train the de-noising model 112. In particular, the de-noising model 112 is trained to more accurately adjust for biases. To that end, bias values and/or characterizations associated with Equations 3 and 4 can be adjusted. However, any other appropriate combination of training data or inputs can be implemented instead.

In some examples, a request for (i) a first bias decomposition task associated with a first processing demand or (ii) a second bias decomposition task associated with a second processing demand is detected. Accordingly, in response to the first processing demand being greater than the second processing demand, the second bias decomposition task can be performed and/or instantiated while the first bias decomposition task is blocked.

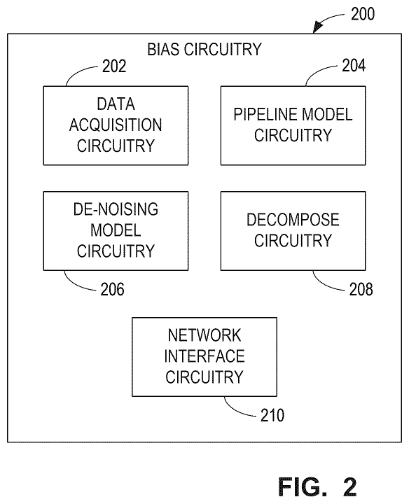

FIG. 2 is a block diagram of example bias circuitry 200 to decompose bias associated with at least one non-cooperating retailer. The bias circuitry 200 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the bias circuitry 200 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

In the illustrated example of FIG. 2, the bias circuitry 200 includes example data acquisition circuitry 202, example pipeline model circuitry 204, example de-noising model circuitry 206, and example decompose circuitry 208. In this example, the bias circuitry 200 can include or be communicatively coupled to network interface circuitry 210.

According to the illustrated example, the data acquisition circuitry 202 acquires and/or accesses source data, which includes RMS data, CPS data, both of which may be corresponding to cooperating and/or non-cooperating retailers. In this example, the source data can, additionally or alternatively, correspond to participating and non-participating manufacturers. The source data can be received via the network interface circuitry 210.

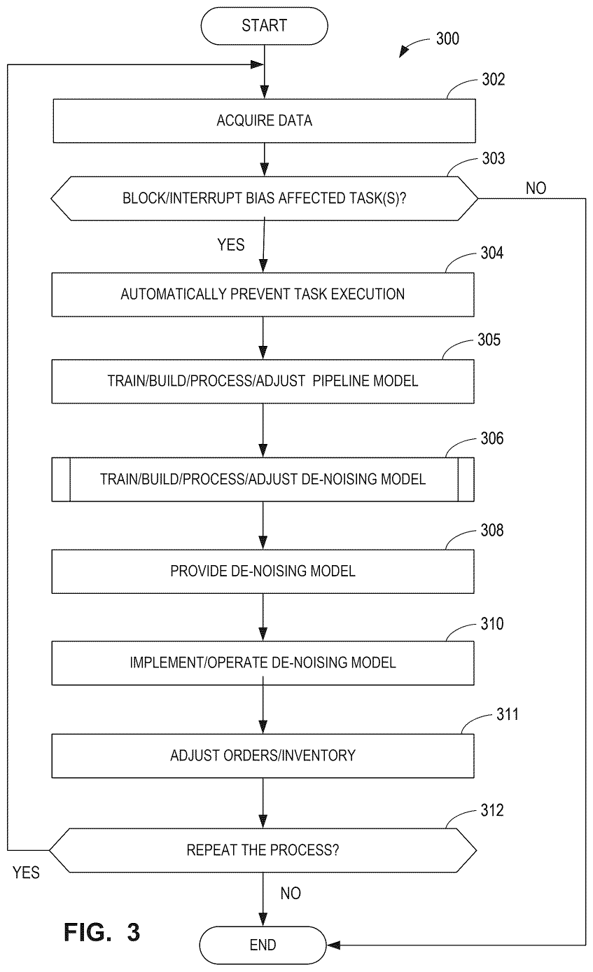

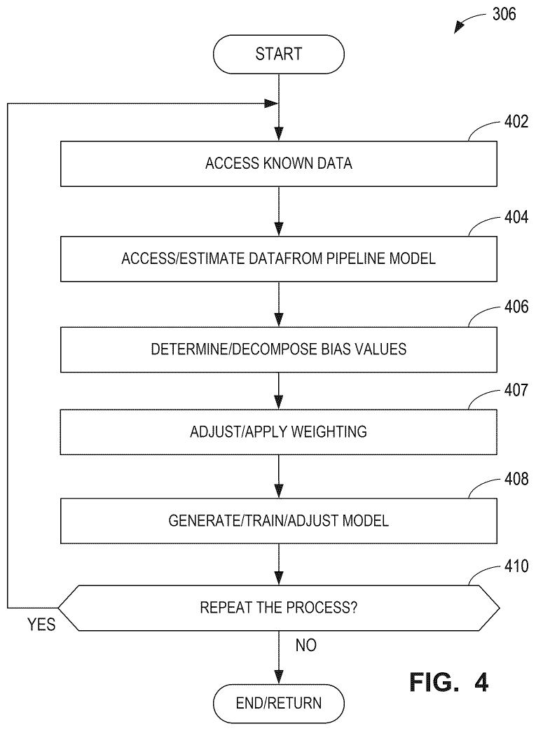

The example pipeline model circuitry (e.g., means for adjusting a pipeline model) 204 defines and/or trains a pipeline model and, in some examples, operates the pipeline model (e.g., in an implementation phase). In this example, the pipeline model circuitry 204 utilizes the remaining stock model to predict inventory/stock levels at different time periods (e.g., weeks), and based on factors associated with promotions. In this example, Alpha and Beta coefficients/parameters, such as described above in connection with example Equation 1, are utilized to scale non promotional sales, as well sales under promotion. In some examples, the pipeline model circuitry 204 is instantiated by programmable circuitry executing pipeline model instructions and/or configured to perform operations such as those represented by the flowcharts of FIGS. 3 and 4.

The de-noising model circuitry (e.g., means for adjusting a de-noising model) 206 of the illustrated example builds, adjusts, processes, trains and executes a de-noising model, as described above in connection with FIG. 1. In this example, the de-noising model is implemented for determination of non-cooperating retailer data based on bias factors, which may or may not be independently related from one another. In some examples, the bias factors are treated as unrelated to one another. According to examples disclosed herein, the de-noising model circuitry 206 operates and/or executes the de-noising model to provide RMS data with respect to a non-cooperating retailer and a non-participating manufacturer. The de-noising model developed, trained and/or generated by the de-noising model circuitry 206 can be deployed to a customer/client/retail site, for example. In some examples, the de-noising model circuitry 206 is instantiated by programmable circuitry executing de-noising model instructions and/or configured to perform operations such as those represented by the flowcharts of FIGS. 3 and 4.

The example decompose circuitry 208 (e.g., means for decomposing bias) decomposes bias factors/values. For example, the decompose circuitry 208 decomposes and/or determines bias values corresponding to different categories of bias for utilization by the de-noising model. While the separation of such bias factors can be typically be difficult to determine, examples disclosed herein enable computationally efficient determination of the bias factors/values by minimizing a value of an equation, such as the example Equation 4. In some examples, the decompose circuitry 208 decomposes bias from a set of CPS data and RMS data (e.g., cooperating and/or non-cooperating retailers, participating and/or non-participating manufacturers, etc.). In some examples, the decompose circuitry 208 is instantiated by programmable circuitry executing decompose instructions and/or configured to perform operations such as those represented by the flowcharts of FIGS. 3 and 4.

In operation, the example network interface circuitry 210 acquires source data, which includes RMS data, CPS data, both of which may associated with cooperating retailers and/or non-cooperating retailers. In some examples, the network interface circuitry 210 is instantiated by programmable circuitry executing data acquisition instructions and/or configured to perform operations such as those represented by the flowcharts of FIGS. 3 and 4.

While an example manner of implementing the bias circuitry 200 is illustrated in FIG. 2, one or more of the elements, processes, and/or devices illustrated in FIG. 2 may be combined, divided, re-arranged, omitted, eliminated, and/or implemented in any other way. Further, the example data acquisition circuitry 202, the example pipeline model circuitry 204, the example de-noising model circuitry 206, the example decompose circuitry 208, the example network interface circuitry 210, and/or, more generally, the example bias circuitry 200 of FIG. 2, may be implemented by hardware alone or by hardware in combination with software and/or firmware. Thus, for example, any of the example data acquisition circuitry 202, the example pipeline model circuitry 204, the example de-noising model circuitry 206, the example decompose circuitry 208, the example network interface circuitry 210, and/or, more generally, the example bias circuitry 200, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example bias circuitry 200 of FIG. 2 may include one or more elements, processes, and/or devices in addition to, or instead of, those illustrated in FIG. 2, and/or may include more than one of any or all of the illustrated elements, processes and devices.

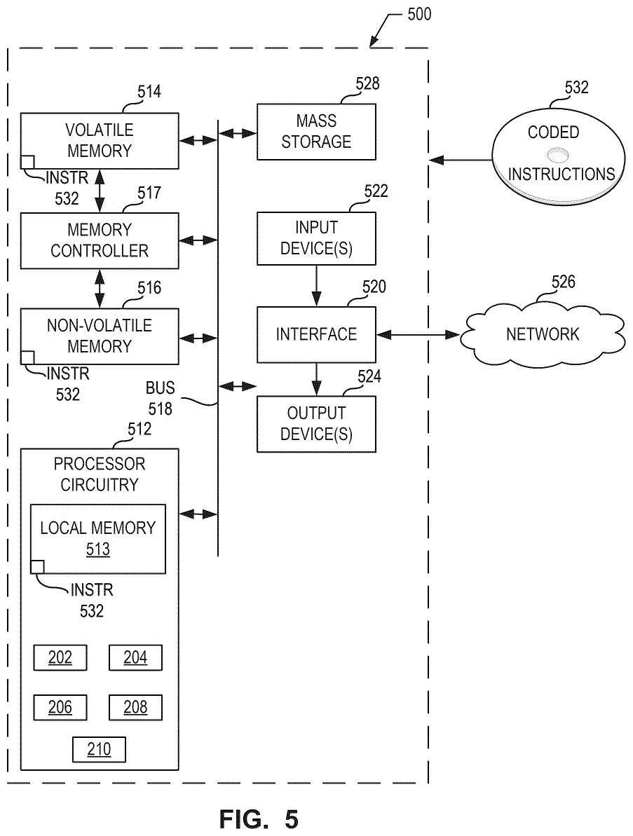

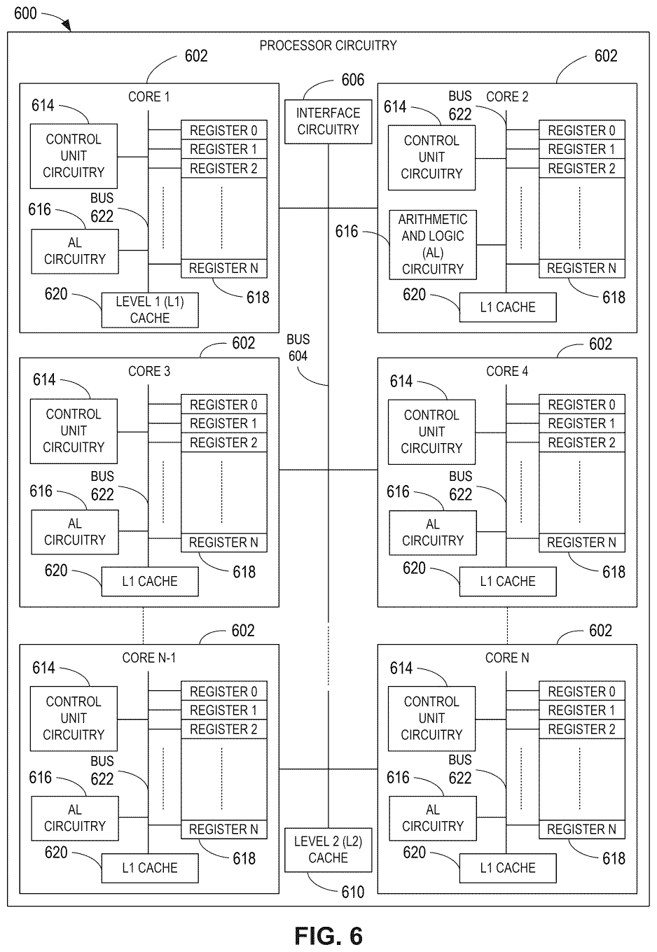

Flowcharts representative of example machine readable instructions, which may be executed by programmable circuitry to implement and/or instantiate the bias circuitry 200 of FIG. 2 and/or representative of example operations which may be performed by programmable circuitry to implement and/or instantiate the bias circuitry 200 of FIG. 2, are shown in FIGS. 3 and 4. The machine readable instructions may be one or more executable programs or portion(s) of one or more executable programs for execution by programmable circuitry such as the programmable circuitry 512 shown in the example processor platform 500 discussed below in connection with FIG. 5 and/or may be one or more function(s) or portion(s) of functions to be performed by the example programmable circuitry (e.g., an FPGA) discussed below in connection with FIGS. 6 and/or 7. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowcharts illustrated in FIGS. 3 and 4, many other methods of implementing the example bias circuitry 200 may alternatively be used. For example, the order of execution of the blocks of the flowcharts may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3 and 4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 3 is a flowchart representative of example machine readable instructions and/or example operations 300 that may be executed, instantiated, and/or performed by programmable circuitry to build, generate and/or adjust a de-noising model for estimation of retail data associated with at least one non-cooperating retailer. In this particular example, the de-noising model is to be utilized to estimate RMS data with respect to a non-cooperating retailer and a non-participating manufacturer. The example machine-readable instructions and/or the example operations 300 of FIG. 3 begin at block 302, at which the example data acquisition circuitry 202 acquires, accesses and/or receives data (e.g., CPS data, RMS data, consumer data, sales data, stock data, shipment data, distribution data, etc.). In this example, the data is received via the example network interface circuitry 210. In some examples, the data acquisition circuitry 202 requests the aforementioned data.

At block 303, in some examples, the example data acquisition circuitry 202 determines whether to block/interrupt at least one bias affected task. For example, some measurement systems initiate particular data intensive tasks in view of suspected bias conditions in the available data. Some tasks include further data acquisition efforts under the assumption that data sample sizes will result in less bias error, but such assumptions become wasteful in terms of computational resource consumption, time and network bandwidth consumption when merely adding a greater volume of data reaffirms the existing bias conditions. As such, in some such examples, the data acquisition circuitry 202 determines whether to block bias mitigation tasks based on whether the aforementioned data has an amount of bias and/or bias indicators that exceed a threshold amount of bias (e.g., exceed a threshold bias value). According to some examples disclosed herein, a request for a first bias decomposition task associated with a first processing demand or a second bias decomposition task associated with a second processing demand is detected. Accordingly, in response to the first processing demand being greater than the second processing demand, the second bias decomposition task can be performed and/or instantiated while the first bias decomposition task is blocked. If the at least one mitigation task is to be blocked/interrupted (block 303), control of the process proceeds to block 304, thereby saving what would otherwise be wasted computational efforts. Otherwise, the process ends (e.g., data analyst preferences to invoke alternate analysis techniques.

At block 304, in some examples, the example data acquisition circuitry 202 prevents execution of tasks. In this example, tasks are prevented from proceeding and, thus, save computational resources until bias is mitigated with further blocks 305-311.

At block 305, the example pipeline model circuitry 204 builds, processes, trains and/or adjusts a pipeline model. In the illustrated example, the pipeline model corresponds to and/or is based on a remaining stock model with Alpha and Beta coefficients. In this example, the remaining stock model of example Equation 1 is utilized. However, any other appropriate example expression, calculation or equation can be implemented instead. According to examples disclosed herein, the example pipeline model circuitry 204 implements and/or executes the pipeline model to predict and/or determine remaining stock with effects of promotions (e.g., promotional sales, seasonal sales, etc.) and shipments. According to examples disclosed herein, the Alpha and Beta coefficients of a pipeline model or similar remaining stock model may be adjusted.

At block 306, as will be discussed below in connection with FIG. 4, the de-noising model circuitry 206 and/or the decompose circuitry 208 of the illustrated example builds, generates, trains and/or adjusts a de-noising model. The de-noising model can be implemented to adjust data and/or calculations based on bias factors determined by the example decompose circuitry 208.

At block 308, in some examples, the de-noising model circuitry 206 provides and/or deploys the de-noising model for execution. In some such examples, the de-noising model can be provided to a retail and/or stock distribution system.

At block 310, in some examples, the de-noising model circuitry 206 implements and/or operates the de-noising model. In this example, the de-noising model circuitry 206 is utilized to estimate and/or generate retail data (e.g., RMS data) corresponding to non-cooperating retailer based on consumer data (e.g., CPS data). In this example, the de-noising model circuitry 206 is utilized to generate the RMS data for the non-cooperating retailer based on output from the pipeline model.

At block 311, in some examples, the de-noising model circuitry 206 adjusts orders, inventory, and/or shipment instructions based on the generated RMS data.

At block 312, it is determined whether to repeat the process. If the process is to be repeated (block 312), control of the process returns to block 302. Otherwise, the process ends. The determination may be based on whether the de-noising model meets a threshold accuracy, whether additional biases are to be accounted for, whether the training data of the de-noising model is stale, whether circumstances (e.g., market conditions, market demographics, etc.) have changed beyond a threshold degree, whether a time period for adjustment as elapsed, etc.

FIG. 4 is a flowchart representative of the example machine readable instructions and/or example operations 306 that may be executed, instantiated, and/or performed by programmable circuitry to build/process the aforementioned de-noising model. The example machine-readable instructions and/or the example operations 306 of FIG. 4 begin at block 402, at which the de-noising model circuitry 206 and/or the decompose circuitry 208 accesses and/or receives known data (e.g., known RMS data, CPS data, shipment data, etc.).

According to examples disclosed herein, at block 404, the de-noising model circuitry 206 and/or the decompose circuitry 208 accesses and/or receives estimate data as output from the pipeline model. For example, the de-noising model circuitry 206 and/or the network interface circuitry 210 receives and/or accesses estimated RMS data corresponding to a non-cooperating retailer in combination with data from a participating manufacturer.

At block 406, the decompose circuitry 208 of the illustrated example determines and/or decomposes bias values based on the known data and the estimated data. In this example, the bias values are calculated for numerous different bias values/values including, but not limited to, retailer bias, category bias, brand bias, promotional bias, etc. In some examples, the decompose circuitry 208 utilizes a combination of CPS data and corresponding RMS data (e.g., corresponding pairs of CPS data and RMS data) to determine the bias values and/or categories.

At block 407, in some examples, the decompose circuitry 208 adjusts weighting of the bias factors. In some such examples, the decompose circuitry 208 applies the weighting to adjust for disproportionate representation.

At block 408, the de-noising model circuitry 206 generates, trains and/or adjusts the de-noising model. In an implementation/inference phase, the de-noising model can utilize the determined bias values to adjust and/or correct data and/or models. In this example, the de-noising model is utilized to generate RMS data for a non-cooperating retailer based on related CMS data as input. Particularly, non-cooperating retailer RMS data corresponding to a non-participating manufacturer is determined based on non-cooperating retailer CPS data associated with a non-participating manufacturer, for example.

At block 410, it is determined whether to repeat the process. If the process is to be repeated (block 410), control of the process returns to block 402. Otherwise, the process ends/returns. The determination may be based on whether the de-noising model necessitates further development, training and/or adjustment, whether subsequent biases are to be analyzed, etc.

FIG. 5 is a block diagram of an example programmable circuitry platform 500 structured to execute and/or instantiate the example machine-readable instructions and/or the example operations of FIGS. 3 and 4 to implement the bias circuitry 200 of FIG. 2. The programmable circuitry platform 500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 500 of the illustrated example includes programmable circuitry 512. The programmable circuitry 512 of the illustrated example is hardware. For example, the programmable circuitry 512 can be implemented by one or more integrated circuits, logic circuits, FPGAs, microprocessors, CPUs, GPUs, DSPs, and/or microcontrollers from any desired family or manufacturer. The programmable circuitry 512 may be implemented by one or more semiconductor based (e.g., silicon based) devices. In this example, the programmable circuitry 512 implements the example data acquisition circuitry 202, the example pipeline model circuitry 204, the example de-noising model circuitry 206, the example decompose circuitry 208, and the example network interface circuitry 210.

The programmable circuitry 512 of the illustrated example includes a local memory 513 (e.g., a cache, registers, etc.). The programmable circuitry 512 of the illustrated example is in communication with main memory 514, 516, which includes a volatile memory 514 and a non-volatile memory 516, by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517. In some examples, the memory controller 517 may be implemented by one or more integrated circuits, logic circuits, microcontrollers from any desired family or manufacturer, or any other type of circuitry to manage the flow of data going to and from the main memory 514, 516.

The programmable circuitry platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user (e.g., a human user, a machine user, etc.) to enter data and/or commands into the programmable circuitry 512. The input device(s) 522 can be implemented by, for example, an audio sensor, a microphone, a camera (still or video), a keyboard, a button, a mouse, a touchscreen, a trackpad, a trackball, an isopoint device, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 500 of the illustrated example also includes one or more mass storage discs or devices 528 to store firmware, software, and/or data. Examples of such mass storage discs or devices 528 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 532, which may be implemented by the machine readable instructions of FIGS. 3 and 4, may be stored in the mass storage device 528, in the volatile memory 514, in the non-volatile memory 516, and/or on at least one non-transitory computer readable storage medium such as a CD or DVD which may be removable.

FIG. 6 is a block diagram of an example implementation of the programmable circuitry 512 of FIG. 5. In this example, the programmable circuitry 512 of FIG. 5 is implemented by a microprocessor 600. For example, the microprocessor 600 may be a general-purpose microprocessor (e.g., general-purpose microprocessor circuitry). The microprocessor 600 executes some or all of the machine-readable instructions of the flowcharts of FIGS. 3 and 4 to effectively instantiate the circuitry of FIG. 2 as logic circuits to perform operations corresponding to those machine readable instructions. In some such examples, the circuitry of FIG. 2 is instantiated by the hardware circuits of the microprocessor 600 in combination with the machine-readable instructions. For example, the microprocessor 600 may be implemented by multi-core hardware circuitry such as a CPU, a DSP, a GPU, an XPU, etc. Although it may include any number of example cores 602 (e.g., 1 core), the microprocessor 600 of this example is a multi-core semiconductor device including N cores. The cores 602 of the microprocessor 600 may operate independently or may cooperate to execute machine readable instructions. For example, machine code corresponding to a firmware program, an embedded software program, or a software program may be executed by one of the cores 602 or may be executed by multiple ones of the cores 602 at the same or different times. In some examples, the machine code corresponding to the firmware program, the embedded software program, or the software program is split into threads and executed in parallel by two or more of the cores 602. The software program may correspond to a portion or all of the machine readable instructions and/or operations represented by the flowcharts of FIGS. 3 and 4.

The cores 602 may communicate by a first example bus 604. In some examples, the first bus 604 may be implemented by a communication bus to effectuate communication associated with one(s) of the cores 602. For example, the first bus 604 may be implemented by at least one of an Inter-Integrated Circuit (I2C) bus, a Serial Peripheral Interface (SPI) bus, a PCI bus, or a PCIe bus. Additionally or alternatively, the first bus 604 may be implemented by any other type of computing or electrical bus. The cores 602 may obtain data, instructions, and/or signals from one or more external devices by example interface circuitry 606. The cores 602 may output data, instructions, and/or signals to the one or more external devices by the interface circuitry 606. Although the cores 602 of this example include example local memory 620 (e.g., Level 1 (L1) cache that may be split into an L1 data cache and an L1 instruction cache), the microprocessor 600 also includes example shared memory 610 that may be shared by the cores (e.g., Level 2 (L2 cache)) for high-speed access to data and/or instructions. Data and/or instructions may be transferred (e.g., shared) by writing to and/or reading from the shared memory 610. The local memory 620 of each of the cores 602 and the shared memory 610 may be part of a hierarchy of storage devices including multiple levels of cache memory and the main memory (e.g., the main memory 514, 516 of FIG. 5). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 602 may be referred to as a CPU, DSP, GPU, etc., or any other type of hardware circuitry. Each core 602 includes control unit circuitry 614, arithmetic and logic (AL) circuitry (sometimes referred to as an ALU) 616, a plurality of registers 618, the local memory 620, and a second example bus 622. Other structures may be present. For example, each core 602 may include vector unit circuitry, single instruction multiple data (SIMD) unit circuitry, load/store unit (LSU) circuitry, branch/jump unit circuitry, floating-point unit (FPU) circuitry, etc. The control unit circuitry 614 includes semiconductor-based circuits structured to control (e.g., coordinate) data movement within the corresponding core 602. The AL circuitry 616 includes semiconductor-based circuits structured to perform one or more mathematic and/or logic operations on the data within the corresponding core 602. The AL circuitry 616 of some examples performs integer based operations. In other examples, the AL circuitry 616 also performs floating-point operations. In yet other examples, the AL circuitry 616 may include first AL circuitry that performs integer-based operations and second AL circuitry that performs floating-point operations. In some examples, the AL circuitry 616 may be referred to as an Arithmetic Logic Unit (ALU).

The registers 618 are semiconductor-based structures to store data and/or instructions such as results of one or more of the operations performed by the AL circuitry 616 of the corresponding core 602. For example, the registers 618 may include vector register(s), SIMD register(s), general-purpose register(s), flag register(s), segment register(s), machine-specific register(s), instruction pointer register(s), control register(s), debug register(s), memory management register(s), machine check register(s), etc. The registers 618 may be arranged in a bank as shown in FIG. 6. Alternatively, the registers 618 may be organized in any other arrangement, format, or structure, such as by being distributed throughout the core 602 to shorten access time. The second bus 622 may be implemented by at least one of an I2C bus, a SPI bus, a PCI bus, or a PCIe bus.

Each core 602 and/or, more generally, the microprocessor 600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 600 is a semiconductor device fabricated to include many transistors interconnected to implement the structures described above in one or more integrated circuits (ICs) contained in one or more packages.

The microprocessor 600 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 600, in the same chip package as the microprocessor 600 and/or in one or more separate packages from the microprocessor 600.

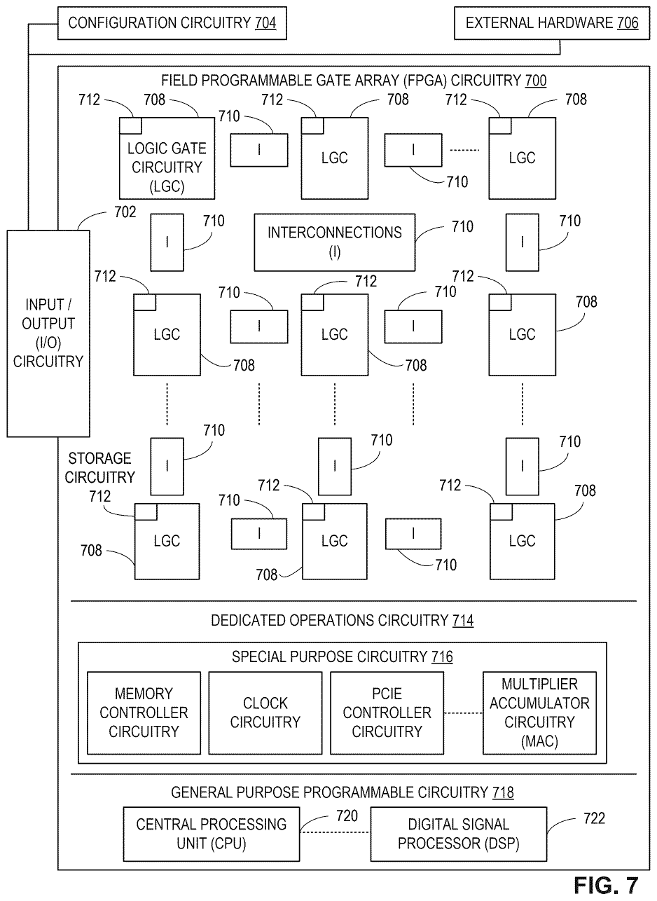

FIG. 7 is a block diagram of another example implementation of the programmable circuitry 512 of FIG. 5. In this example, the programmable circuitry 512 is implemented by FPGA circuitry 700. For example, the FPGA circuitry 700 may be implemented by an FPGA. The FPGA circuitry 700 can be used, for example, to perform operations that could otherwise be performed by the example microprocessor 600 of FIG. 6 executing corresponding machine readable instructions. However, once configured, the FPGA circuitry 700 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 600 of FIG. 6 described above (which is a general purpose device that may be programmed to execute some or all of the machine readable instructions represented by the flowcharts of FIGS. 3 and 4 but whose interconnections and logic circuitry are fixed once fabricated), the FPGA circuitry 700 of the example of FIG. 7 includes interconnections and logic circuitry that may be configured, structured, programmed, and/or interconnected in different ways after fabrication to instantiate, for example, some or all of the operations/functions corresponding to the machine readable instructions represented by the flowcharts of FIGS. 3 and 4. In particular, the FPGA circuitry 700 may be thought of as an array of logic gates, interconnections, and switches. The switches can be programmed to change how the logic gates are interconnected by the interconnections, effectively forming one or more dedicated logic circuits (unless and until the FPGA circuitry 700 is reprogrammed). The configured logic circuits enable the logic gates to cooperate in different ways to perform different operations on data received by input circuitry. Those operations may correspond to some or all of the instructions (e.g., the software and/or firmware) represented by the flowcharts of FIGS. 3 and 4. As such, the FPGA circuitry 700 may be configured and/or structured to effectively instantiate some or all of the operations/functions corresponding to the machine readable instructions of the flowcharts of FIGS. 3 and 4 as dedicated logic circuits to perform the operations/functions corresponding to those software instructions in a dedicated manner analogous to an ASIC. Therefore, the FPGA circuitry 700 may perform the operations/functions corresponding to the some or all of the machine readable instructions of FIGS. 3 and 4 faster than the general-purpose microprocessor can execute the same.

In the example of FIG. 7, the FPGA circuitry 700 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 700 of FIG. 7 may access and/or load the binary file to cause the FPGA circuitry 700 of FIG. 7 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 700 of FIG. 7 to cause configuration and/or structuring of the FPGA circuitry 700 of FIG. 7, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 700 of FIG. 7 may access and/or load the binary file to cause the FPGA circuitry 700 of FIG. 7 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 700 of FIG. 7 to cause configuration and/or structuring of the FPGA circuitry 700 of FIG. 7, or portion(s) thereof.

The FPGA circuitry 700 of FIG. 7, includes example input/output (I/O) circuitry 702 to obtain and/or output data to/from example configuration circuitry 704 and/or external hardware 706. For example, the configuration circuitry 704 may be implemented by interface circuitry that may obtain a binary file, which may be implemented by a bit stream, data, and/or machine-readable instructions, to configure the FPGA circuitry 700, or portion(s) thereof. In some such examples, the configuration circuitry 704 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 706 may be implemented by external hardware circuitry. For example, the external hardware 706 may be implemented by the microprocessor 600 of FIG. 6.

The FPGA circuitry 700 also includes an array of example logic gate circuitry 708, a plurality of example configurable interconnections 710, and example storage circuitry 712. The logic gate circuitry 708 and the configurable interconnections 710 are configurable to instantiate one or more operations/functions that may correspond to at least some of the machine readable instructions of FIGS. 3 and 4 and/or other desired operations. The logic gate circuitry 708 shown in FIG. 7 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 708 to enable configuration of the electrical structures and/or the logic gates to form circuits to perform desired operations/functions. The logic gate circuitry 708 may include other electrical structures such as look-up tables (LUTs), registers (e.g., flip-flops or latches), multiplexers, etc.

The configurable interconnections 710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 708 to program desired logic circuits.

The storage circuitry 712 of the illustrated example is structured to store result(s) of the one or more of the operations performed by corresponding logic gates. The storage circuitry 712 may be implemented by registers or the like. In the illustrated example, the storage circuitry 712 is distributed amongst the logic gate circuitry 708 to facilitate access and increase execution speed.

The example FPGA circuitry 700 of FIG. 7 also includes example dedicated operations circuitry 714. In this example, the dedicated operations circuitry 714 includes special purpose circuitry 716 that may be invoked to implement commonly used functions to avoid the need to program those functions in the field. Examples of such special purpose circuitry 716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 700 may also include example general purpose programmable circuitry 718 such as an example CPU 720 and/or an example DSP 722. Other general purpose programmable circuitry 718 may additionally or alternatively be present such as a GPU, an XPU, etc., that can be programmed to perform other operations.

Although FIGS. 6 and 7 illustrate two example implementations of the programmable circuitry 512 of FIG. 5, many other approaches are contemplated. For example, FPGA circuitry may include an on-board CPU, such as one or more of the example CPU 720 of FIG. 6. Therefore, the programmable circuitry 512 of FIG. 5 may additionally be implemented by combining at least the example microprocessor 600 of FIG. 6 and the example FPGA circuitry 700 of FIG. 7. In some such hybrid examples, one or more cores 602 of FIG. 6 may execute a first portion of the machine readable instructions represented by the flowcharts of FIGS. 3 and 4 to perform first operation(s)/function(s), the FPGA circuitry 700 of FIG. 7 may be configured and/or structured to perform second operation(s)/function(s) corresponding to a second portion of the machine readable instructions represented by the flowcharts of FIGS. 3 and 4, and/or an ASIC may be configured and/or structured to perform third operation(s)/function(s) corresponding to a third portion of the machine readable instructions represented by the flowcharts of FIGS. 3 and 4.

It should be understood that some or all of the circuitry of FIG. 2 may, thus, be instantiated at the same or different times. For example, same and/or different portion(s) of the microprocessor 600 of FIG. 6 may be programmed to execute portion(s) of machine-readable instructions at the same and/or different times. In some examples, same and/or different portion(s) of the FPGA circuitry 700 of FIG. 7 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 600 of FIG. 6 may execute machine readable instructions in one or more threads executing concurrently and/or in series. In some examples, the FPGA circuitry 700 of FIG. 7 may be configured and/or structured to carry out operations/functions concurrently and/or in series. Moreover, in some examples, some or all of the circuitry of FIG. 2 may be implemented within one or more virtual machines and/or containers executing on the microprocessor 600 of FIG. 6.

In some examples, the programmable circuitry 512 of FIG. 5 may be in one or more packages. For example, the microprocessor 600 of FIG. 6 and/or the FPGA circuitry 700 of FIG. 7 may be in one or more packages. In some examples, an XPU may be implemented by the programmable circuitry 512 of FIG. 5, which may be in one or more packages. For example, the XPU may include a CPU (e.g., the microprocessor 600 of FIG. 6, the CPU 720 of FIG. 7, etc.) in one package, a DSP (e.g., the DSP 722 of FIG. 7) in another package, a GPU in yet another package, and an FPGA (e.g., the FPGA circuitry 700 of FIG. 7) in still yet another package.

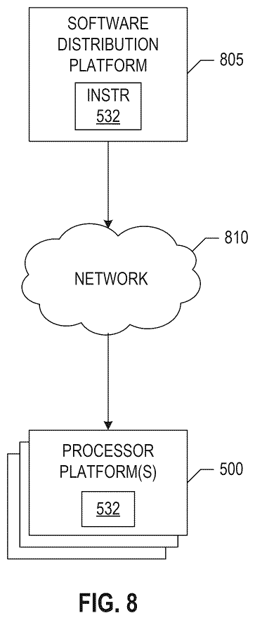

A block diagram illustrating an example software distribution platform 805 to distribute software such as the example machine readable instructions 532 of FIG. 5 to other hardware devices (e.g., hardware devices owned and/or operated by third parties from the owner and/or operator of the software distribution platform) is illustrated in FIG. 8. The example software distribution platform 805 may be implemented by any computer server, data facility, cloud service, etc., capable of storing and transmitting software to other computing devices. The third parties may be customers of the entity owning and/or operating the software distribution platform 805. For example, the entity that owns and/or operates the software distribution platform 805 may be a developer, a seller, and/or a licensor of software such as the example machine readable instructions 532 of FIG. 5. The third parties may be consumers, users, retailers, OEMs, etc., who purchase and/or license the software for use and/or re-sale and/or sub-licensing. In the illustrated example, the software distribution platform 805 includes one or more servers and one or more storage devices. The storage devices store the machine readable instructions 532, which may correspond to the example machine readable instructions of FIGS. 3 and 4, as described above. The one or more servers of the example software distribution platform 805 are in communication with an example network 810, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 532 from the software distribution platform 805. For example, the software, which may correspond to the example machine readable instructions of FIGS. 3 and 4, may be downloaded to the example programmable circuitry platform 500, which is to execute the machine readable instructions 532 to implement the bias circuitry 200. In some examples, one or more servers of the software distribution platform 805 periodically offer, transmit, and/or force updates to the software (e.g., the example machine readable instructions 532 of FIG. 5) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to enable computationally and accurate determination of consumer retail data are disclosed herein. Further examples and combinations thereof include the following:

Example 1 includes At least one non-transitory machine-readable medium comprising machine-readable instructions to cause at least one processor circuit to at least decompose at least one bias of first consumer panel services (CPS) data, and adjust a de-noising model based on the at least one bias, the de-noising model to generate retail measurement services (RMS) data based on second CPS data corresponding to a non-cooperating retailer.

Example 2 includes the machine-readable medium as defined in example 1, wherein the instructions cause one or more of the at least one processor circuit to execute the de-noising model to generate the RMS data.

Example 3 includes the machine-readable medium as defined in any of examples 1 or 2, wherein a pipeline model is to train the de-noising model with output therefrom, and wherein the output includes estimated RMS data determined by the pipeline model based on shipment data.

Example 4 includes the machine-readable medium as defined in any of examples 1 to 3, wherein the RMS data is first RMS data, and wherein the at least one bias is decomposed based on the first CPS data and second RMS data, the first CPS data and the second RMS data corresponding to a cooperating retailer.

Example 5 includes the machine-readable medium as defined in any of examples 1 to 4, wherein the RMS data is first RMS data, and wherein the at least one bias is decomposed based on the first CPS data and second RMS data, the first CPS data and the second RMS data corresponding to the non-cooperating retailer.

Example 6 includes the machine-readable medium as defined in example 5, wherein the first RMS data is associated with a non-participating manufacturer and the second RMS data is associated with a participating manufacturer.

Example 7 includes the machine-readable medium as defined in any of examples 1 to 6, wherein the at least one bias is decomposed by minimizing a difference between a known RMS value and an estimated RMS value.

Example 8 includes the machine-readable medium as defined in any of examples 1 to 7, wherein the RMS data is first RMS data and the non-cooperating retailer is a first non-cooperating retailer, and wherein the instructions cause one or more of the at least one processor circuit to train a pipeline model with (i) shipment data corresponding to a cooperating retailer and (ii) second RMS data corresponding to the cooperating retailer, the pipeline model to determine an RMS estimate of a second non-cooperating retailer as input to the de-noising model.

Example 9 includes the machine-readable medium as defined in example 8, wherein the instructions cause one or more of the at least one processor circuit to execute the pipeline model to operate a remaining stock model.

Example 10 includes an apparatus comprising interface circuitry, machine-readable instructions, and at least one processor circuit to be programmed by the machine-readable instructions to detect a request to instantiate a first bias decomposition task or a second bias decomposition task, the first bias decomposition task associated with a first processing demand and the second bias decomposition task associated with a second processing demand, block the first bias decomposition task based on the first processing demand being greater than the second processing demand, and instantiate the second bias decomposition task by decomposing at least one bias of first consumer panel services (CPS) data, and adjusting a de-noising model based on the at least one bias, the de-noising model to generate retail measurement services (RMS) data based on second CPS data corresponding to a non-cooperating retailer.

Example 11 includes the apparatus as defined in example 10, wherein one or more of the at least one processor circuit is to execute the de-noising model to generate the RMS data.

Example 12 includes the apparatus as defined in any of examples 10 or 11, wherein a pipeline model is to train the de-noising model with output therefrom, and wherein the output includes estimated RMS data determined by the pipeline model based on shipment data.

Example 13 includes the apparatus as defined in any of examples 10 to 12, wherein the RMS data is first RMS data, and wherein the at least one bias is decomposed based on the first CPS data and second RMS data, the first CPS data and the second RMS data corresponding to a cooperating retailer.

Example 14 includes the apparatus as defined in any of examples 10 to 13, wherein the RMS data is first RMS data, and wherein the at least one bias is decomposed based on the first CPS data and second RMS data, the first CPS data and the second RMS data corresponding to the non-cooperating retailer.

Example 15 includes the apparatus as defined in example 14, wherein the first RMS data and the second RMS data are associated with at least one participating manufacturer.

Example 16 includes the apparatus as defined in any of examples 10 to 15, wherein the at least one bias is decomposed by minimizing a difference between a known RMS value and an estimated RMS value.

Example 17 includes a method comprising decomposing at least one bias of first consumer panel services (CPS) data and adjusting a de-noising model based on the at least one bias, the de-noising model to generate retail measurement services (RMS) data based on second CPS data corresponding to a non-cooperating retailer.

Example 18 includes the method as defined in example 17, further including executing the de-noising model to generate the RMS data.

Example 19 includes the method as defined in any of examples 17 or 18, wherein a pipeline model is to provide output to train the de-noising model, and wherein the output includes estimated RMS data, the estimated RMS data determined by the pipeline model based on shipment data.

Example 20 includes the method as defined in any of examples 17 to 19, wherein the RMS data is first RMS data, and wherein the at least one bias is decomposed based on the first CPS data and second RMS data, the first CPS data and the second RMS data corresponding to a cooperating retailer.

Example 21 includes the method as defined in any of examples 17 to 20, wherein the RMS data is first RMS data, and wherein the de-noising model and a pipeline model that provides output to the de-noising model are trained with second RMS data corresponding to a cooperating retailer.

Example 22 includes the method as defined in example 21, wherein the first RMS data is associated with a non-participating manufacturer, and wherein the second RMS data is associated with a participating manufacturer.

Example 23 includes the method as defined in any of examples 17 to 22, wherein the at least one bias is decomposed by minimizing a difference between a known RMS value and an estimated RMS value.

Example 24 includes an apparatus comprising means for decomposing bias, the means for decomposing bias to decompose at least one bias from first consumer panel services (CPS) data, and means for adjusting a de-noising model, the means for adjusting the de-noising model to adjust the de-noising model for generation of retail measurement services (RMS) data based on second CPS data corresponding to a non-cooperating retailer.

Example 25 includes the apparatus as defined in example 24, further including means for adjusting a pipeline model, the pipeline model to provide input to the de-noising model.

Example 26 includes the apparatus as defined in example 25, wherein the means for adjusting the pipeline model is to train the pipeline model with shipment data corresponding to a cooperating retailer.

Example 27 includes the apparatus as defined in example 26, wherein the pipeline model is trained with estimated RMS data that is generated by the pipeline model based on the shipment data.

Example 28 includes the apparatus as defined in any of examples 24 to 27, wherein the means for adjusting the de-noising model is to train the de-noising model with CPS data from the non-cooperating retailer.

Example 29 includes the apparatus as defined in any of examples 24 to 28, wherein the RMS data is first RMS data, and wherein the at least one bias is decomposed based on the first CPS data and second RMS data, the first CPS data and the second RMS data corresponding to the non-cooperating retailer.

Example 30 includes the apparatus as defined in any of examples 24 to 29, wherein the means for decomposing bias is to decompose the at least one bias by minimizing a difference between a known RMS value and an estimated RMS value. From the foregoing, it will be appreciated that example systems, apparatus, articles of manufacture, and methods have been disclosed that enable accurate adjustment of consumer/retail data that would otherwise be laborious and time-consuming to aid in forecasting and stock management, amongst other advantages. Disclosed systems, apparatus, articles of manufacture, and methods improve the efficiency of using a computing device by enabling efficient adjustment of stock/inventory models while reducing a need for computationally intensive analysis as well as data aggregation typically necessitated in known techniques, such as crowd sourcing, cash slip store intercept, etc. Disclosed systems, apparatus, articles of manufacture, and methods are accordingly directed to one or more improvement(s) in the operation of a machine such as a computer or other electronic device.

It is noted that this patent claims priority from U.S. Provisional Patent Application No. 63/578,143 which was filed on Aug. 22, 2023, and is hereby incorporated by reference in its entirety.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. At least one non-transitory machine-readable medium comprising machine-readable instructions to cause at least one processor circuit to at least:
decompose at least one bias of first consumer panel services (CPS) data; and
adjust a de-noising model based on the at least one bias, the de-noising model to generate retail measurement services (RMS) data based on second CPS data corresponding to a non-cooperating retailer.

2. The machine-readable medium as defined in claim 1, wherein the instructions cause one or more of the at least one processor circuit to execute the de-noising model to generate the RMS data.

3. The machine-readable medium as defined in claim 1, wherein a pipeline model is to train the de-noising model with output therefrom, and wherein the output includes estimated RMS data determined by the pipeline model based on shipment data.

4. The machine-readable medium as defined in claim 1, wherein the RMS data is first RMS data, and wherein the at least one bias is decomposed based on the first CPS data and second RMS data, the first CPS data and the second RMS data corresponding to a cooperating retailer.

5. The machine-readable medium as defined in claim 1, wherein the RMS data is first RMS data, and wherein the at least one bias is decomposed based on the first CPS data and second RMS data, the first CPS data and the second RMS data corresponding to the non-cooperating retailer.

6. The machine-readable medium as defined in claim 5, wherein the first RMS data is associated with a non-participating manufacturer and the second RMS data associated with a participating manufacturer.

7. The machine-readable medium as defined in claim 1, wherein the at least one bias is decomposed by minimizing a difference between a known RMS value and an estimated RMS value.

8. The machine-readable medium as defined in claim 1, wherein the RMS data is first RMS data and the non-cooperating retailer is a first non-cooperating retailer, and wherein the instructions cause one or more of the at least one processor circuit to train a pipeline model with (i) shipment data corresponding to a cooperating retailer and (ii) second RMS data corresponding to the cooperating retailer, the pipeline model to determine an RMS estimate of a second non-cooperating retailer as input to the de-noising model.

9. The machine-readable medium as defined in claim 8, wherein the instructions cause one or more of the at least one processor circuit to execute the pipeline model to operate a remaining stock model.

10. An apparatus comprising:
interface circuitry;
machine-readable instructions; and
at least one processor circuit to be programmed by the machine-readable instructions to:
detect a request to instantiate a first bias decomposition task or a second bias decomposition task, the first bias decomposition task associated with a first processing demand and the second bias decomposition task associated with a second processing demand;
block the first bias decomposition task based on the first processing demand being greater than the second processing demand; and
instantiate the second bias decomposition task by:
decomposing at least one bias of first consumer panel services (CPS) data, and
adjusting a de-noising model based on the at least one bias, the de-noising model to generate retail measurement services (RMS) data based on second CPS data corresponding to a non-cooperating retailer.

11. The apparatus as defined in claim 10, wherein one or more of the at least one processor circuit is to execute the de-noising model to generate the RMS data.

12. The apparatus as defined in claim 10, wherein a pipeline model is to train the de-noising model with output therefrom, and wherein the output includes estimated RMS data determined by the pipeline model based on shipment data.

13. The apparatus as defined in claim 10, wherein the RMS data is first RMS data, and wherein the at least one bias is decomposed based on the first CPS data and second RMS data, the first CPS data and the second RMS data corresponding to a cooperating retailer.

14. The apparatus as defined in claim 10, wherein the RMS data is first RMS data, and wherein the at least one bias is decomposed based on the first CPS data and second RMS data, the first CPS data and the second RMS data corresponding to the non-cooperating retailer.

15. The apparatus as defined in claim 14, wherein the first RMS data and the second RMS data are associated with at least one participating manufacturer.

16. The apparatus as defined in claim 10, wherein the at least one bias is decomposed by minimizing a difference between a known RMS value and an estimated RMS value.

17. A method comprising:
decomposing at least one bias of first consumer panel services (CPS) data; and
adjusting a de-noising model based on the at least one bias, the de-noising model to generate retail measurement services (RMS) data based on second CPS data corresponding to a non-cooperating retailer.

18. The method as defined in claim 17, further including executing the de-noising model to generate the RMS data.

19. The method as defined in claim 17, wherein a pipeline model is to provide output to train the de-noising model, and wherein the output includes estimated RMS data, the estimated RMS data determined by the pipeline model based on shipment data.

20. The method as defined in claim 17, wherein the RMS data is first RMS data, and wherein the at least one bias is decomposed based on the first CPS data and second RMS data, the first CPS data and the second RMS data corresponding to a cooperating retailer.

21.-30. (canceled)
